(19) United States
(12) Patent Application Publication
(10) Pub. No.: US 2025/0193748 A1
(43) Pub. Date: Jun. 12, 2025

(54) METHOD AND USER-EQUIPMENT FOR HANDLING NETWORK ACCESS DURING HANDOVER FROM 3GPP NETWORK TO NON-3GPP NETWORK

(71) Applicant: SAMSUNG ELECTRONICS CO., LTD., Suwon-si (KR)

(72) Inventors: Mayank MITTAL, Bangalore (IN); Krishnamurthy Doddaballapur RAMU, Bangalore (IN); Vishal YADAV, Bangalore (IN); Arijit SEN, Bangalore (IN)

(73) Assignee: SAMSUNG ELECTRONICS CO., LTD., Suwon-si (KR)

(21) Appl. No.: 18/912,040

(22) Filed: Oct. 10, 2024

Related U.S. Application Data
(63) Continuation of application No. PCT/KR2024/009865, filed on Jul. 10, 2024.

(30) Foreign Application Priority Data
Dec. 9, 2023 (IN) 202341084051

(51) Int. Cl. H04W 36/00; H04L 65/1016; H04W 36/36

(52) U.S. Cl. CPC H04W 36/00222; H04L 65/1016; H04W 36/362

(57) ABSTRACT

A method for handling network access during by a User Equipment (UE) in a wireless communication system, may include: identifying an initiation of a handover from a 3GPP network to a non-3GPP network; determining whether the handover is initiated during an ongoing call at the UE, or an always-on packet data unit (PDU) session at the UE; suspending at least one suspended real-time transport protocol (RTP) packet on the 3GPP network to prevent transmission of at least one service request to the 3GPP network during the handover based on the handover being initiated during the ongoing call at the UE, and configuring a status of the always-on PDU session as inactive for the 3GPP network to prevent the transmission of the at least one service request to the 3GPP network during the handover based on the handover being initiated during the always-on PDU session at the UE.

### CROSS-REFERENCE TO RELATED APPLICATIONS

This application is a continuation application, claiming priority under § 365(c), of an International application No. PCT/KR2024/009865, filed on Jul. 10, 2024, which is based on and claims the benefit of a Indian patent application number 202341084051, filed on Dec. 9, 2023, in the Indian Intellectual Property Office, the disclosure of which is incorporated by reference herein in its entirety.

### BACKGROUND

### 1. Field

The present disclosure is related to wireless communication technology. More particularly, the present disclosure is related to a method and user equipment for handling network access during handover from 3GPP network to non-3GPP network.

### 2. Description of Related Art

In general, in wireless communication technology a handover is a process of achieving continuous service by a User Equipment (UE) as the user moves between cells. In the related art, there are two types of handover: an intracell handover, and an intercell handover. The intracell handover is a process of switching the UE from one physical channel of the cell to another physical channel of the same cell. The intercell handover is a process of switching the UE from one cell to another cell. Further, there are two types of intercell handover: inter Base Station Controller (BSC), and inter Mobile Switching Centres (MSC). Inter BSC handover is a handover of the UE from one cell to another cell controlled by different BSCs. The inter BSC handover is controlled by the MSC. Similarly, the inter MSC handover is a handover of the UE from one cell to another cell controlled by different MSCs.

It is possible to handover a Packet Data Unit (PDU) session of a UE from 3^{rd} Generation Partnership Project (3GPP) access to non-3GPP access. The handover of the PDU session of the UE from the 3GPP access to non-3GPP access can occur based on at least one of: radio conditions, user interactions, user mobility, call movements, and the like. For example, the handover of 3GPP to non-3GPP can be considered as moving a call of the UE moving from New Radio (5G) to at least one Wi-fi, Wi-max, and Bluetooth. FIG. 1A, illustrates a scenario of handover of the UE from 3GPP network to non-3GPP network. Initially, consider at operation 1 (S-1) the UE (101) is accessing on 3GPP network (103). Further, at operation 2 (S-2), the UE (101) moves towards the non-3GPP network (105). The handover of the UE (101) from 3GPP network to non-3GPP network can be because of call movement, user mobility and the like. After the handover, the UE (101) at operation 3 (S-3) establishes a new PDU session with the non-3GPP network (105) for further access using non-3GPP network.

The handover of the PDU session from 3GPP access to non-3GPP access can be performed as per specification TS 23.502, Clause 4.9.2.2 V17. According to specification TS 23.502 4.12.5, during the handover of the UE from 3GPP to non-3GPP, if the UE is not registered via non-3GPP access, the UE will initiate a registration clause. Further, the UE performs PDU session establishment as per the PDU session establishment procedure using a PDU session ID. Further, if the User Plane of the PDU session is activated in 3GPP access, the Session Management Function (SMF) releases resources over source 3GPP access. However, the PDU session shall not be released and hence the SMF will not send the PDU session release command to the UE. Since the PDU session is not released, the session management context between the Access and Mobility Management Function (AMF) and the SMF is maintained. Thus, as a result, the PDU session can be active at the UE for a short duration on 3GPP access until notification received from the upper layer to locally release PDU session after a successful handover from 3GPP to non-3GPP access, which can cause a service request on 3GPP access for pending RTP packets for the short duration. Hence, the transmission of the service request for pending RTP packets at the UE will create an abnormality on the network side, and the network can enter an unexpected state. The unexpected state is a state which is not expected at the network side.

### SUMMARY

There is a need for improved method for handling network access during handover of the UE from 3GPP network to non-3GPP network.

Embodiments herein can provide a method for handling network access during handover of a User Equipment (UE) from 3GPP network to non-3GPP network.

Embodiments herein can also handle synchronization between the UE and network during the handover of a PDU session in 5G from 3GPP to non-3GPP.

Embodiments herein can avoid the unnecessary usage of user plane resources and unnecessary service request triggered for PDU sessions during the handover from 3GPP network to non-3GPP network.

Embodiments herein can avoid unnecessary PDU movement from non-3GPP to 3GPP access for always-on PDU sessions.

According to one or more example embodiments, a method for handling network access by a user equipment (UE) in a wireless communication system, may include: identifying an initiation of a handover of the UE from a 3GPP network to a non-3GPP network; determining whether the handover is initiated during one of an ongoing call at the UE, or an always-on packet data unit (PDU) session at the UE; suspending at least one suspended real-time transport protocol (RTP) packet on the 3GPP network to prevent transmission of at least one service request to the 3GPP network during the handover, based on the handover being initiated during the ongoing call at the UE, and configuring a status of the always-on PDU session as inactive for the 3GPP network to prevent the transmission of the at least one service request to the 3GPP network during the handover, based on the handover being initiated during the always-on PDU session at the UE.

The method further may include: receiving at least one received RTP packet from an internet protocol multimedia subsystem (IMS) to trigger the at least one service request to the 3GPP network to get user plane resources for an IMS PDU, during the handover; and storing the at least one received RTP packet to avoid triggering of the at least one service request to the 3GPP network during the handover, to obtain at least one stored RTP packet.

The method may further include: based on the handover being initiated during the ongoing call at the UE, determining whether the handover is successful; deleting the at least one suspended RTP packet, based on the handover being successful; and resuming transmission of the at least one suspended RTP packet on the 3GPP network, based on the handover being unsuccessful.

The method further may include: based on the handover being initiated during the ongoing call at the UE, determining whether the handover is successful; performing, by the UE, one of: routing the at least one stored RTP packet and the at least one suspended RTP packet on the non-3GPP network, based on the handover being successful; and resuming transmission of the at least one stored RTP packet and the at least one suspended RTP packet on the 3GPP network, based on the handover being unsuccessful.

The method further may include: deleting the at least one stored RTP packet.

For the handover during the ongoing call, the method may further include: registering for access to the 3GPP network; starting a call on the 3GPP network based on the registering, by initiating an internet protocol multimedia subsystem (IMS) PDU session; moving from the 3GPP network to the non-3GPP network, during the ongoing call; establishing a secure connection with the non-3GPP network; moving from the IMS PDU session from the 3GPP network to the non-3GPP network; and receiving, from 3GPP network, a data radio bearer (DRB) release on the 3GPP network new radio (NR) once connection is moved to the non-3GPP network.

Prevention of transmission of the at least one service request to the 3GPP network during the handover may occur may be caused due to at least one of: not releasing the IMS PDU session corresponding to the ongoing call by a session management function (SMF) so as to maintain a session management context between an access and mobility management function (AMF) and the SMF, releasing, by the 3GPP network, a corresponding DRB for the PDU session while moving the IMS PDU session from 3GPP access to non-3GPP access, and at least one pending RTP packet to be sent on the 3GPP access during the handover.

Configuring the status of the always-on PDU session as inactive for the 3GPP network may include: starting an internet key exchange (IKEv2) session on the non-3GPP network; transmitting the initiation of the handover to the 3GPP network through the non-3GPP network at a predefined trigger point; and configuring the status of the always-on PDU session as inactive for the 3GPP network.

The method may further include: based on the handover being initiated during the always-on PDU session at the UE, receiving the initiation of the handover during the always-on PDU session at the UE; and configuring the status of the always-on PDU session from inactive to active for the 3GPP network.

A user equipment (UE) for handling network access in a wireless communication system, may include: memory storing instructions; and at least one processor coupled to the memory, wherein the instructions, when executed by the at least one processor, cause the UE to perform operations. The operations may include: identifying an initiation of a handover of the UE from a 3GPP network to a non-3GPP network; determining whether the handover is initiated during an ongoing call at the UE, or an always-on packet data unit (PDU) session at the UE; and suspending at least one suspended real-time transport protocol (RTP) packet on the 3GPP network to prevent transmission of at least one service request to the 3GPP network during the handover, based on the handover being initiated during the ongoing call at the UE; and configuring a status of the always-on PDU session as inactive for the 3GPP network to prevent the transmission of the at least one service request to the 3GPP network during the handover, based on the handover being initiated during the always-on PDU session at the UE.

A non-transitory computer readable storage medium storing instructions, which, when executed by at least one processor of a user equipment (UE) cause the UE to perform operations. The operations may include: identifying an initiation of a handover of the UE from a 3GPP network to a non-3GPP network; determining whether the handover is initiated during an ongoing call at the UE, or an always-on packet data unit (PDU) session at the UE; and suspending at least one suspended real-time transport protocol (RTP) packet on the 3GPP network to prevent transmission of at least one service request to the 3GPP network during the handover, based on the handover being initiated during the ongoing call at the UE; and configuring a status of the always-on PDU session as inactive for the 3GPP network to prevent the transmission of the at least one service request to the 3GPP network during the handover, based on the handover being initiated during the always-on PDU session at the UE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

The above and other aspects, features, and advantages of certain embodiments of the disclosure will be more apparent from the following description taken in conjunction with the accompanying drawings, in which:

FIG. 1A illustrates an example scenario of a handover of UE from 3GPP network to non-3GPP network, according to related art;

FIG. 1B is a sequence diagram illustrating the process of handover of the UE from 3GPP network to non-3GPP network, according to related art;

FIG. 1C is a sequence diagram illustrating the process of handover of the UE from 3GPP network to non-3GPP network during always-on PDU session, according to related art;

FIG. 1D is a block diagram illustrating the process of handover of the UE from 3GPP network to non-3GPP network, according to related art;

FIG. 1E is a block diagram illustrating the process of handover of the UE from 3GPP network to non-3GPP network during always-on PDU session, according to related art;

FIG. 2 is a block diagram illustrating an User Equipment for handling network access during a handover from a 3GPP network to non-3GPP network, according to the embodiments as disclosed herein;

FIG. 3A is a block diagram illustrating the method of handling the handover of the UE from 3GPP network to non-3GPP network, according to the embodiments as disclosed herein;

FIG. 3B is a sequence diagram illustrating the method of handling the handover of the UE from 3GPP network to non-3GPP network, according to the embodiments as disclosed herein;

FIG. 3C is a sequence diagram illustrating the method of handling the handover of the UE from 3GPP network to non-3GPP network, according to the embodiments as disclosed herein;

FIG. 3D is a sequence diagram illustrating the method of handling the handover of the UE from 3GPP network to non-3GPP network, according to the embodiments as disclosed herein;

FIG. 4A is a sequence diagram illustrating the method of handling the handover of the UE from 3GPP network to non-3GPP network during always-on PDU session, according to the embodiments as disclosed herein; and

FIG. 4B is a block diagram illustrating the method of handling the handover of the UE from 3GPP network to non-3GPP network during always-on PDU session, according to the embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

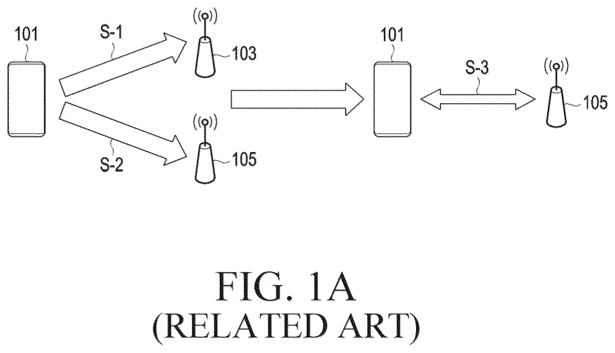

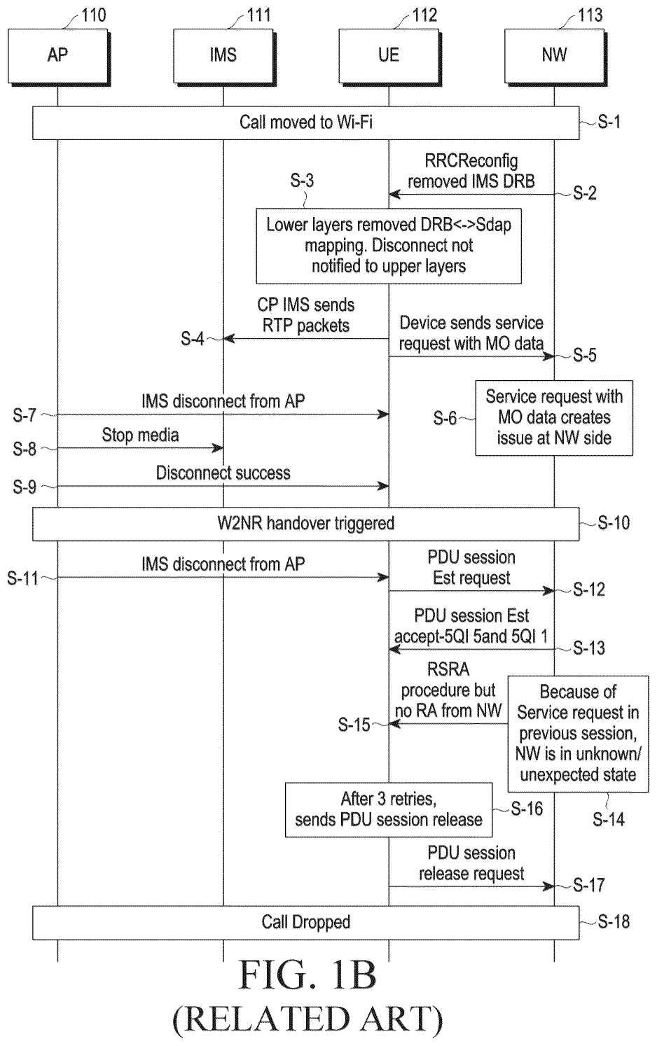

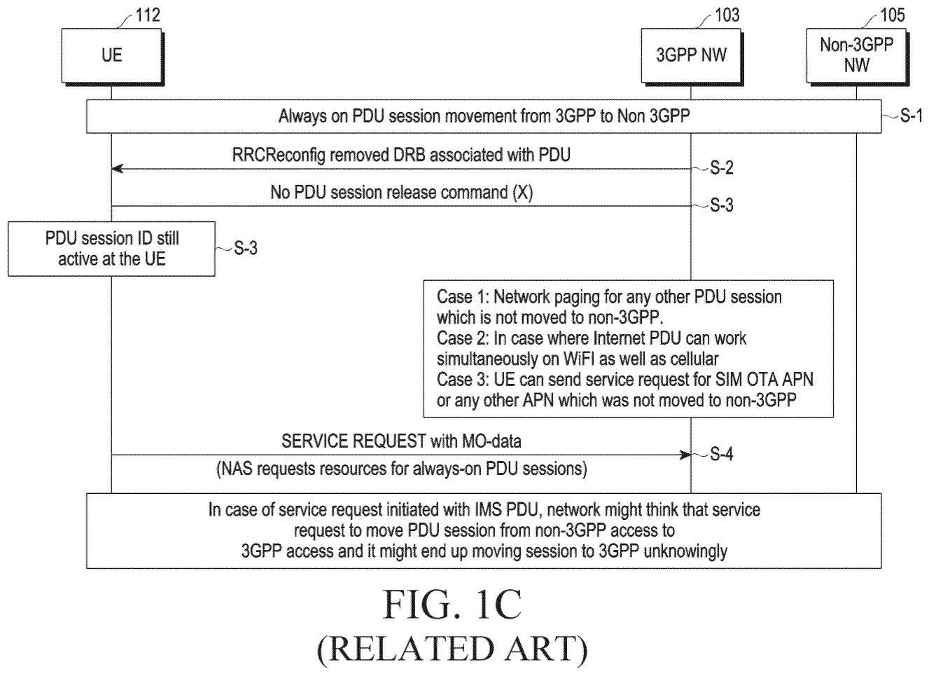

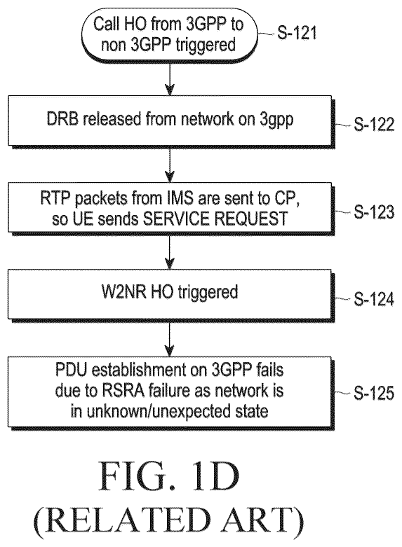

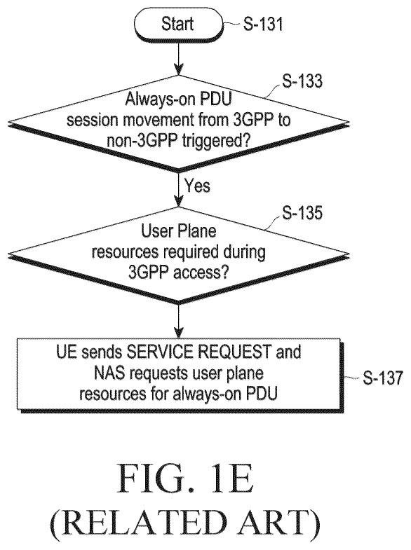

FIG. 1B is a sequence diagram illustrating the process of handover of the UE from 3GPP network to non-3GPP network, according to related art;

Referring to the FIG. 1B, consider for example a handover of a UE (112) from 3GPP network to non-3GPP network. Initially, before the initiation of the handover, the UE (112) established an IMS PDU session (111) with 3GPP network (113) for the data communication. For example, consider the UE (112) registered on New Radio (NR) started a VoNR (Voice over New Radio) call. Further, the UE (112) moves from 3GPP network to non-3GPP network. For example, the call of the UE (112) has been moved from NR to WiFi as shown in S-1. Thereafter, the UE (112) establishes Internet Protocol Security (IPSEC) connection with non-3GPP network and the IMS PDU session is moved to Evolved Packet Data Gateway (EPDG). Upon the establishment, the 3GPP network (113) sends RRC reconfiguration message to the UE (112) for releasing the Data Radio bearer associated with the 3GPP network at operation (S-2). However, there can be a small delay in informing Communication Processor (CP) about the handover from 3GPP to non-3GPP by the internal modules of the UE (112). Due to the delay caused, the CP of the UE (112) will send the RTP packets the IMS PDU session is still active on the 3GPP network (113) with UE (112). Hence, the UE (112) receives RTP packets from the upper modules 3GPP network as shown in operation S-4. Upon receipt of the RTP packets, the UE (112) transmits the service request with Mobile Originated (MO) data to the 3GPP network as shown in operation (S-5). The service request can include but is not limited to a handover request, call set up request, and data session initiation. Since the UE (112) is connected using non-3GPP, the service request with MO data creates an issue at the 3GPP network as shown in operation (S-6). The UE (112) disconnects the IMS PDU session from the Application Processor (AP) (110) as shown in operation (S-7). The AP (110) (the upper layers of the 3GPP network) stops sending the media data over the IMS PDU session (111) as shown in operation (S-8). The UE (112) is disconnected from the 3GPP network at operation (S-9). Further, W2NR handover is again triggered at operation (S-10). Upon the W2NR trigger, the IMS PDU handover takes place from Wifi at operation (S-11), where the handover of the UE (112) is performed from the non-3GPP network to the 3GPP network. Upon PDU session handover from the non-3GPP network, the UE (112) transmits a PDU session Establishment (Est) request to the 3GPP network (113) at operation (S-12). The UE (112) successfully establishes the PDU session with the 3GPP network by receiving the PDU session Est and accepts 5QI5 and 5QI1 at operation (S-13). However, the 3GPP network is in an unknown state as shown in operation (S-14), due to the transmission service request during handover of 3GPP to non-3GPP in the previous session. RSRA procedure occurs but no RA from NW at operation (S-15). After 3 attempts, sends PDU session release at operation (S-16). Thereafter, a request of PDU session release is generated at operation (S-17). Thus, call is dropped at operation (S-18).

FIG. 1C is a sequence diagram illustrating the process of handover of the UE from 3GPP network to non-3GPP network during an always-on PDU session, according to related art;

Referring to the FIG. 1C, consider the UE (112) makes a decision to move an always-on PDU session to non-3GPP in operation (S-1). Thereafter, the 3GPP network (103) transmits the RRC Reconfiguration message to the UE (112) to release the Data Radio bearer associated with the PDU session at operation (S-2). However, the 3GPP network does not send the PDU session release command to the UE (112) and the PDU session is still active on the 3GPP network as indicated in operation (S-3). Further, at least one of the scenarios comprising network paging for any other PDU session which is not moved to non-3GPP, PDU working simultaneously on Wifi and cellular, and UE sending the service request for SIM OTA APN or any other APN, which was not moved to non-3GPP, the UE (112) can send the service request with MO-data at operation (S-4). The transmission of service request at operation (S-4) is possible due to the active PDU session on the 3GPP network. Finally, the transmission of the service request initiated with the IMS PDU session on the 3GPP network can mislead the 3GPP network. Particularly, due to the reception of the service request, the 3GPP network might think to move from non-3GPP to 3GPP. Hence, the always-on PDU session may create an unnecessary service request. Thus, the 3GPP network may go into the unknown or unexpected state.

FIG. 1D is a block diagram illustrating the process of handover of the UE from 3GPP network to non-3GPP network, according to related art;

Referring to the FIG. 1D, considering a scenario, a UE is connected to the 3GPP network and the handover takes place from the 3GPP network to non-3GPP network as shown in operation (S-121). When a call HO from 3GPP to non-3GPP is triggered, then the Data Radio Bearer (DRB) is released from the network on 3GPP at operation (S-122). Further, RTP packets are transmitted from IMS are sent to CP. Upon the receipt of RTP packets, the UE sends a service request to the 3GPP network at operation (S-123). Since as indicated in operation (S-122), only the DRB resources are released on the 3GPP network and not the PDU session established with the UE (112). Thus, the transmission of the service request from the UE may make the 3GPP network to go into the bad state. Further, when W2NR Handover is triggered again at operation (s-124), the UE (112) needs to move from non-3GPP network to 3GPP network. However, the PDU session establishment on the 3GPP network fails due to RSRA failure since the network is in bad state as indicated in operation (S-125).

FIG. 1E is a block diagram illustrating the process of handover of the UE from 3GPP network to non-3GPP network during always-on PDU session, according to related art;

Referring to the FIG. 1E, Consider At operation (S-131), a call starts with the 3GPP network on an always-on PDU session. Further, at operation (S-133) it is determined whether the always-on PDU session moves from 3GPP to non-3GPP network. When the always-on PDU session is determined to move from 3GPP to non-3GPP network, it is determined whether user plane resources are required during 3GPP access at operation (S-135). Further, when the user plane resources are required during 3GPP access, the UE (112) sends the service request and Network Attached Storage (NAS) requests user plane resources for the always-on PDU session. Thus, the transmission of the service request with the always-on PDU session, can make the PDU session move from non-3GPP to 3GPP.

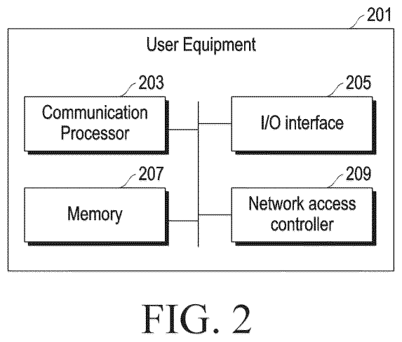

FIG. 2 is a block diagram illustrating an User Equipment for handling network access during a handover from a 3GPP network to non-3GPP network, according to the embodiments as disclosed herein. The user equipment (201) includes a communication processor (203), an Input/Output (I/O) interface (205), a memory (207), and a network access controller (209). The User Equipment (UE) (201) is a device used directly by an end-user to communicate. For example, the UE can include, but not limited to mobile device, laptop, desktop computer, and tablet.

Referring to the FIG. 2, a user equipment (201) in which communication processor (203), memory (207), input/output interface (205) and network access controller (209) are interconnected to each other. The UE (201) is configured to handle network access during the handover from a 3GPP network to non-3GPP network. Further, the communication processor (203) of the UE (201) communicates with the memory (207), input/output interface (205) and network access controller (209). The processor (203) is configured to execute instructions stored in the memory (207) and to perform various processes. The processor (203) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (207) of the UE (201) includes storage locations to be addressable through the processor (203). The memory (207) is not limited to a volatile memory and/or a non-volatile memory. Further, the memory (207) can include one or more computer-readable storage media. The memory (207) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (207) can store the media streams such as audios stream, video streams, haptic feedbacks and the like.

The I/O interface (205) transmits the information between the memory (207) and external peripheral devices. The peripheral devices are the input-output devices associated with the network apparatus (301). The I/O interface (205) receives several information from plurality of UEs, network devices, server and the like.

The network access controller (209) of the UE (201) communicates with the processor (203), I/O interface (205) and memory (207) to handle network access during the handover of the UE (201) from 3GPP network to non-3GPP network. The network access controller (209) may be implemented through at least one processor. The network controller (209) and the communication processor (203) may be integrally referred to as at least one processor. The network access controller (209) initially receives an indication of handover of the UE (201) from 3GPP network to non-3GPP network. The indication is provided from the non-3GPP network. Further, the network access controller (209) determines whether the handover is initiated during one of an ongoing call at the UE and always-on PDU session at the UE (201). Furthermore, the network access controller (209) suspends at least one Real-Time Transport Protocol (RTP) packet on the 3GPP network to prevent transmission of at least one service request to the 3GPP network during the handover of the UE (201) from the 3GPP network to the non-3GPP network, when the handover is initiated during the ongoing call at the UE (201).

In an embodiment, during the always-on PDU session, the network access controller (209) handles the network access during the handover from 3GPP network to non-3GPP network. During the handover, the network access controller (209) initiates an Internet Key Exchange (IKEv2) session on the non-3GPP network. Further, the network access controller (209) transmits an indication of the initiation of the handover from non-3GPP network to 3GPP network. Thereafter, the network access controller (209) configures a status of the always-on PDU session as inactive for the 3GPP network. Configuring the status to be inactive, the network access controller (209) prevents the transmission of the at least one service request from the 3GPP network during the handover from 3GPP network to non-3GPP network. The prevention of the service request from the 3GPP network avoids the unnecessary PDU session movement from non-3GPP network to 3GPP network.

Hence, the network access controller (209) handles the network access during the handover from 3GPP network to non-3GPP network. The network access controller (209) suspends and buffer the incoming RTP packets from the PDU session established with the 3GPP network during the handover from 3GPP network to non-3GPP network. Also, the network access controller (209) configures the status of the always-on PDU session as inactive during the handover from 3GPP network to non-3GPP network. Thus, the network access controller (209) optimizes the handover process from 3GPP network to non-3GPP network. Also, the network access controller (209) avoids the unnecessary movement of PDU session from non-3GPP network to 3GPP network during the always-on PDU session. Furthermore, the network access controller (209) maintains a synchronization with the network during the handover from 3GPP to non-3GPP network.

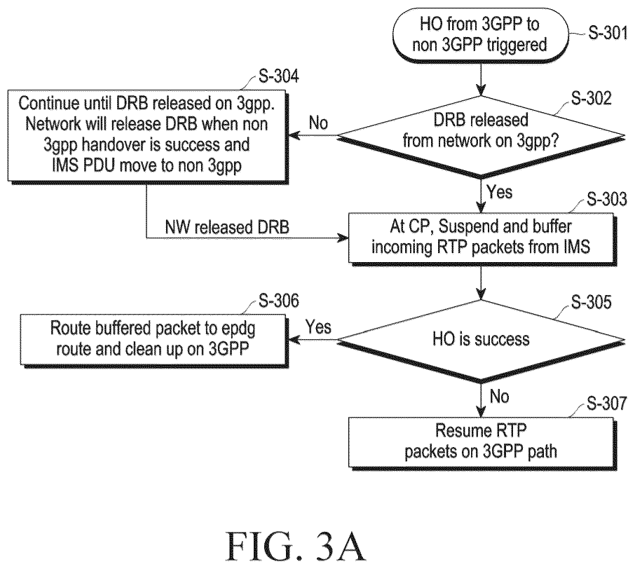

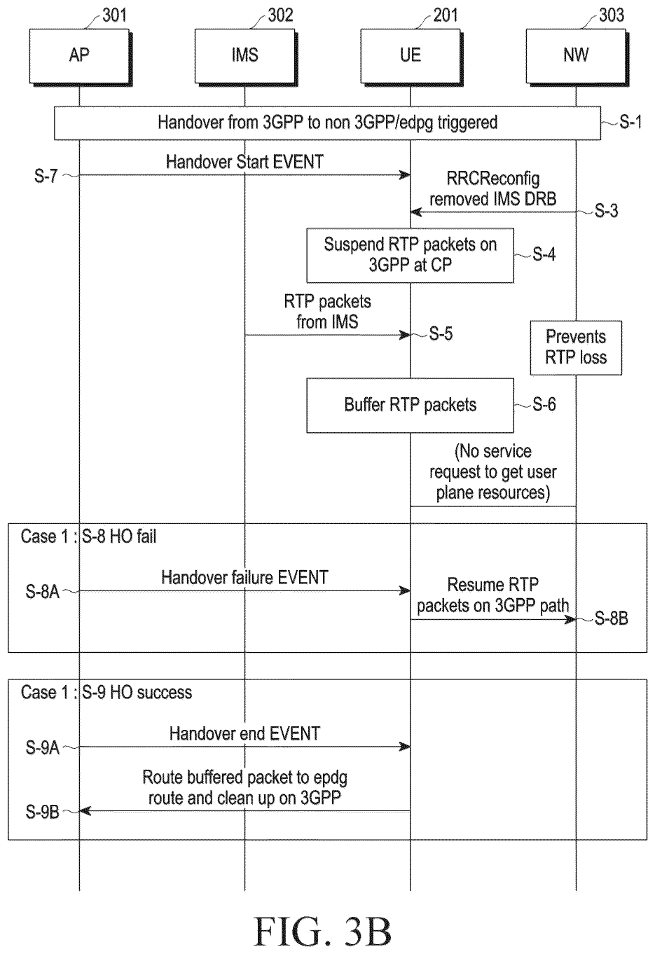

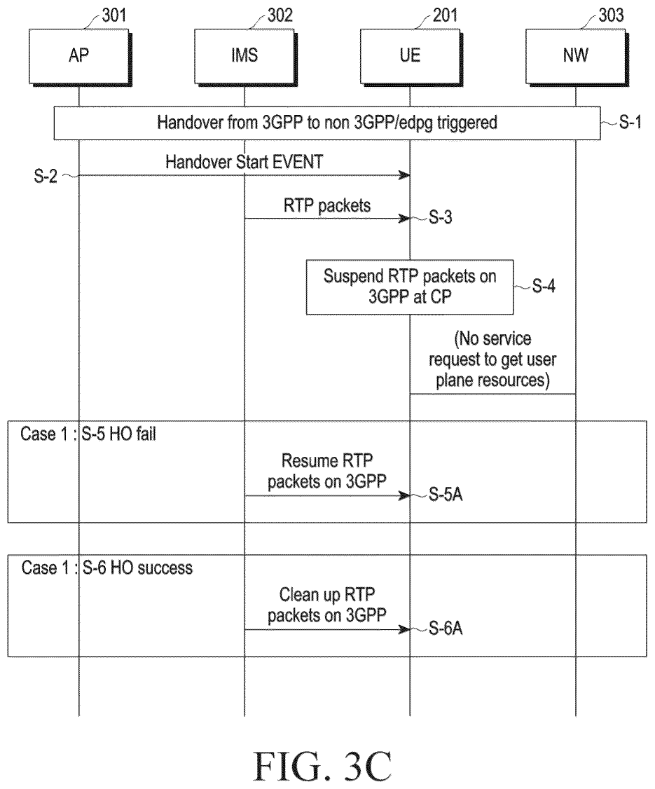

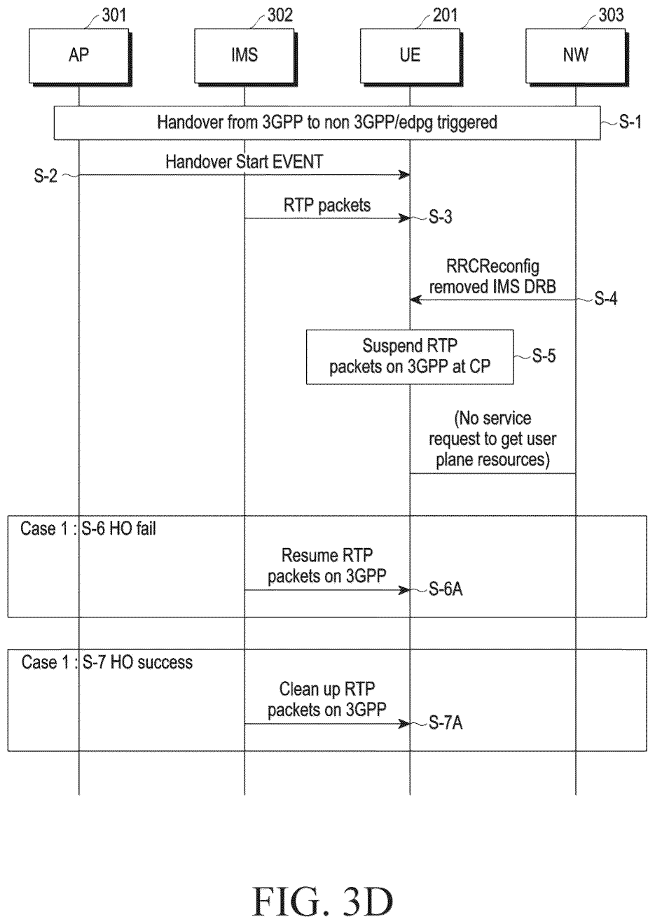

FIG. 3A is a block diagram illustrating the method of handling the handover of the UE from 3GPP network to non-3GPP network, according to the embodiments as disclosed herein.

Referring to FIG. 3A, at operation (S-301), consider the initiation of the handover of the UE (201) from 3GPP network to non-3GPP network. Upon, the initiation of the handover, the non-3GPP network transmits the notification of the initiation of the handover to UE (201). Further, at operation (S-302), the network access controller (209) determines whether the DRB associated with 3GPP network is released. Further, when the DRB is determined to be not released then, at operation (S-304) the network access controller (209) will continue to operate on 3GPP network until the DRB release message is received and the handover is successful from 3GPP to non-3GPP. Further, when the DRB is determined to be released, then at operation (S-303) the network access controller (209) suspends and buffers incoming RTP packets from the PDU session on the 3GPP network. Thereafter, at the operation (S-305) the network access controller (209) determines whether the handover is successful from 3GPP to non-3GPP network. Finally, at operation (S-306) upon the successful handover, the network access controller (209) routes the buffered packets to the non-3GPP network and also cleans the all the buffered packets. Also, at operation (S-307), the network access controller (209), resumes the buffered RTP packets to the 3GPP network, when the handover is not successful.

FIG. 3B is a sequence diagram illustrating the method of handling the handover of the UE from 3GPP network to non-3GPP network, according to the embodiments as disclosed herein.

Referring to FIG. 3B, consider a handover of the UE (201) from 3GPP to non-3GPP network is triggered at operation (S-1). The UE (201) comprises a communication processor. Upon the trigger of the handover, at operation S-2, the Application Processor (AP) (301) indicates the initiation of the handover from 3GPP to non-3GPP network. Further, at operation S-3, the UE (201) receives a Radio Resource Configuration (RRC) message from the network indicating the release of the DRB associated with the 3GPP network. However, the PDU session on the 3GPP network is still active. Upon the release of DRB, at operation (S-4), the UE (201), suspends all the RTP packets that are ready for the transmission on active PDU Session on the 3GPP network. Also, at the operation (S-5) the UE (201) can receive the RTP packets from the 3GPP network over an active PDU session. Further, at operation (S-6) the UE (201) buffers all the received RTP packets over the active PDU session. Thus, suspending of the RTP packets and buffering of the RTP packets at the UE (201) prevents the loss of RTP packets at the network (303) side. Furthermore, upon the unsuccessful handover of the UE (201) from the 3GPP to non-3GPP network, at operation (S-8A) the UE (201) receives a message indicating the failure event from the Application Processor (301)/non-3GPP. Upon the receipt of the indication of unsuccessful handover, at operation (S-8B), the UE (201) resumes the buffered RTP packets to the 3GPP network. Finally, upon the successful handover, at operation (S-9) the application processor (301) transmits a message to the UE (201) indicating the completion of successful handover from 3GPP to non 3GPP network. Further, at operation (S-9B), the UE (201) transmits all the buffered RTP packets to the non-3GPP network.

FIG. 3C is a sequence diagram illustrating the method of handling the handover of the UE from 3GPP network to non-3GPP network, according to the embodiments as disclosed herein.

Referring to FIG. 3C, consider a handover of the UE (201) from 3GPP to non-3GPP network is triggered at operation (S-1). The UE (201) comprises a communication processor. Upon the trigger of the handover, at operation (S-2), the Application Processor (AP) (301) indicates the initiation of the handover from 3GPP to non-3GPP network. Upon the initiation of the handover, at operation (S-3) the UE (201) can receive RTP packets from the PDU session (302) on the 3GPP network. Further, at operation (S-4) the UE (201) suspends all the received RTP packets and cleans any pending RTP packets that was buffered but not discarded. Furthermore, upon unsuccessful handover at operation (S-5), the UE (201) resumes the transmission of the RTP to the 3GPP network (303) over a PDU session (302) as shown in operation (S-5A). Also, upon the successful handover from 3GPP to non-3GPP network, at operation (6A) the UE (201), cleans all the incoming RTP packets, received from the 3GPP network over the IMS PDU session (302).

FIG. 3D is a sequence diagram illustrating the method of handling the handover of the UE from 3GPP network to non-3GPP network, according to the embodiments as disclosed herein.

Referring to FIG. 3D, consider a handover of the UE (201) from 3GPP to non-3GPP network is triggered at operation (S-1). Upon the trigger of the handover, at operation S-2, the Application Processor (AP) (301) indicates the initiation of the handover from 3GPP to non-3GPP network. Further, at operation (S-3), the UE (201) can receive the packets from the 3GPP network over an active IMS PDU session (302). Furthermore, at operation (S-4), the UE (201) receives a Radio Resource Configuration (RRC) message from the non 3GPP network (303) indicating the release of the DRB associated with the 3GPP network. However, the PDU session on the 3GPP network is still active. Upon the release of DRB, at operation (S-5), the UE (201), suspends all the RTP packets that are ready for the transmission on active PDU Session on the 3GPP network. Furthermore, at operation (S-6) upon the unsuccessful handover of the UE (201) from the 3GPP to non-3GPP network, the UE (201), at operation (S-6A), the UE (201) receives the RTP packets from the 3GPP network over an IMS PDU session (302). Finally, at operation (S-7), upon the successful handover, the UE (201) cleans up all the RTP packets received from the 3GPP network as shown in operation (S-7A).

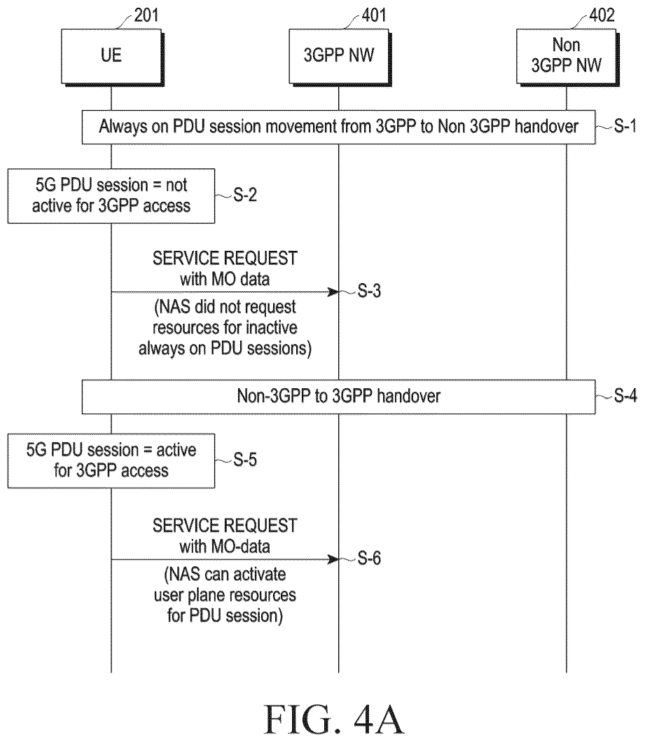

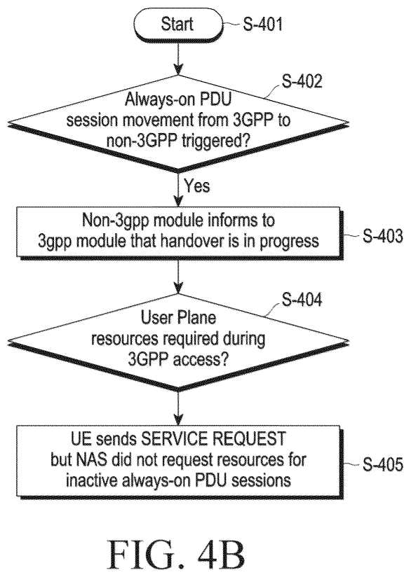

FIG. 4A is a sequence diagram illustrating the method of handling the handover of the UE from 3GPP network to non-3GPP network during always-on PDU session, according to the embodiments as disclosed herein.

Referring to FIG. 4A, consider a handover of the UE (201) from 3GPP network (401) to non-3GPP network (402) during always-on PDU session as shown in operation (S-1). Further, upon the initiation of the handover of the UE (201), the UE (201) establishes an IKEv2 session with the non-3GPP network (402). Upon the successful establishment of the IKEv2 session, the UE (201) receives a notification from the non-3GPP network (402), about the handover from the 3GPP (401) to non-3GPP network (402). Further, the UE (201) configures the status of the always-on PDU session as not active as shown in operation (S-2). Thereafter, the UE (201) transmits a service request to the 3GPP (401) network with Mobile Originated (MO) data at operation (S-3). At operation (S-3), the UE (201) did not request resources from the 3GPP network (401) since the always-on PDU session was inactivated. The inactivation of the always-on PDU session avoids the unnecessary movement of the UE (201) from non-3GPP network to 3GPP network. Further, consider the UE (201) moves from the non-3GPP network (402) to the 3GPP network (401) as shown in operation (S-4). Upon the initiation of the handover from the non-3GPP network (402) to 3GPP network (401), the UE (201) configures the status of the always-on PDU session as active at operation (S-5). Finally, during the transmission of the service request by the UE (201), the Non-Access Stratum (NAS) message activates the user plane resources for the PDU session as shown in operation (S-6). Also, the UE (201) can continue to operate in the 3GPP network (401) with proper synchronization between the UE (201) and 3GPP network (401).

FIG. 4B is a block diagram illustrating the method of handling the handover of the UE from 3GPP network to non-3GPP network during always-on PDU session, according to the embodiments as disclosed herein.

Referring to FIG. 4B, initially consider at operation (S-401), a handover of the UE (201) from the 3GPP network to non-3GPP network. Further, at operation (S-402), the UE determines whether always-on PDU session handover from the 3GPP network to non-3GPP network is triggered. Upon determining, the always-on PDU session handover from the non 3GPP network to 3GPP network, at operation (S-403), the non-3GPP module informs the 3GPP module about the handover of the UE (201) is performed. Particularly, the UE (201) configures the always-on PDU session to be inactive. Further, at operation (S-404) the UE (201) determines whether User Plane resources are required during the 3GPP access. Finally, if the user plane resources are determined to be required, then at operation (S-405), the UE (201) sends the service request to the 3GPP network, but the NAS message did not request the resources during the always-on PDU session, because the always-on PDU session is inactivated. Thus, the inactivation of the always-on PDU session, performed by the UE (201), during the handover from 3GPP network to non-3GPP network, avoids the unnecessary movement from the non-3GPP network to 3GPP network.

For example, in always-on Packet Data Unit (PDU) session, during the handover of the UE (201) from 3GPP network to non-3GPP network, there may certain instances, where the UE (201) can request the service from the 3GPP network. For example, consider a scenario of network paging. The network paging allows the mobile network to locate and notify mobile station of an incoming call or message. During, network paging for any other PDU session which is not moved to non-3GPP network, there may be chances of the UE (201) moving from the non-3GPP network to 3GPP network due to the always-on PDU session. Hence, the UE (201) deactivates the always-on PDU session while transmitting the service request. Thus, preventing the unnecessary movement of the UE (201) from the non-3GPP network to the 3GPP network. Similarly, during an instance when the internet PDU can work simultaneously on Wi-Fi and cellular, the inactivation of the always-on PDU session during the handover from the 3GPP network to non-3GPP network, prevents the unnecessary movement from non-3GPP network to 3GPP network. In an embodiment, when UE (201) sends a service request for any other Access Point Name (APN) which was not moved to non-3GPP, then the inactivation of the always-on PDU session prevents the unnecessary movement of the UE (201) from non-3GPP network to 3GPP network.

While certain embodiments of the disclosure has been particularly shown and described, it will be understood that various changes in form and details may be made therein without departing from the spirit and scope of the following claims.

What is claimed is:

1. A method for handling network access by a user equipment (UE) in a wireless communication system, the method comprising:
identifying an initiation of a handover of the UE from a 3rd generation partnership project (3GPP) network to a non-3GPP network;
determining whether the handover is initiated during an ongoing call at the UE, or an always-on packet data unit (PDU) session at the UE;
suspending at least one suspended real-time transport protocol (RTP) packet on the 3GPP network to prevent transmission of at least one service request to the 3GPP network during the handover, based on the handover being initiated during the ongoing call at the UE); and
configuring a status of the always-on PDU session as inactive for the 3GPP network to prevent the transmission of the at least one service request to the 3GPP network during the handover, based on the handover being initiated during the always-on PDU session at the UE.

2. The method of claim 1, further comprising:
receiving at least one received RTP packet from an internet protocol multimedia subsystem (IMS) to trigger the at least one service request to the 3GPP network to get user plane resources for an IMS PDU, during the handover; and
storing the at least one received RTP packet to avoid triggering of the at least one service request to the 3GPP network during the handover, to obtain at least one stored RTP packet.

3. The method of claim 1, further comprising: based on the handover being initiated during the ongoing call at the UE:
determining whether the handover is successful;
deleting the at least one suspended RTP packet, based on the handover being successful; and
resuming transmission of the at least one suspended RTP packet on the 3GPP network, based on the handover being unsuccessful.

4. The method of claim 2, further comprising:
based on the handover being initiated during the ongoing call at the UE, determining whether the handover is successful;
routing the at least one stored RTP packet and the at least one suspended RTP packet on the non-3GPP network, based on the handover being successful; and
resuming transmission of the at least one stored RTP packet and the at least one suspended RTP packet on the 3GPP network, based on the handover being unsuccessful.

5. The of claim 4, further comprising: method deleting the at least one stored RTP packet.

6. The method of claim 1, wherein for the handover during the ongoing call, the method further comprises:
registering for access to the 3GPP network;
starting a call on the 3GPP network based on the registering, by initiating an internet protocol multimedia subsystem (IMS) PDU session;
moving from the 3GPP network to the non-3GPP network, during the ongoing call;
establishing a secure connection with the non-3GPP network;
moving from the IMS PDU session from the 3GPP network to the non-3GPP network; and
receiving, from 3GPP network, a data radio bearer (DRB) release on the 3GPP network new radio (NR) once connection is moved to the non-3GPP network.

7. The method of claim 6, wherein prevention of transmission of the at least one service request to the 3GPP network during the handover occurs is caused due to at least one of:
not releasing the IMS PDU session corresponding to the ongoing call by a session management function (SMF) so as to maintain a session management context between an access and mobility management function (AMF) and the SMF,
releasing, by the 3GPP network, a corresponding DRB for the PDU session while moving the IMS PDU session from 3GPP access to non-3GPP access, and
at least one pending RTP packet to be sent on the 3GPP access during the handover.

8. The method of claim 1, wherein configuring the status of the always-on PDU session as inactive for the 3GPP network comprises:
starting an internet key exchange (IKEv2) session on the non-3GPP network;
transmitting the initiation of the handover to the 3GPP network through the non-3GPP network at a predefined trigger point; and
configuring the status of the always-on PDU session as inactive for the 3GPP network.

9. The method of claim 1, further comprising:
based on the handover being initiated during the always-on PDU session at the UE, receiving the initiation of the handover during the always-on PDU session at the UE; and
configuring the status of the always-on PDU session from inactive to active for the 3GPP network.

10. A user equipment (UE) for handling network access in a wireless communication system, the UE comprising:
a memory storing instructions; and
at least one processor coupled to the memory, wherein the instructions, when executed by the at least one processor, cause the UE to perform operations comprising:
identifying an initiation of a handover of the UE from a 3rd generation partnership project (3GPP) network to a non-3GPP network;
determining whether the handover is initiated during an ongoing call at the UE, or an always-on packet data unit (PDU) session at the UE;
suspending at least one suspended real-time transport protocol (RTP) packet on the 3GPP network to prevent transmission of at least one service request to the 3GPP network during the handover, based on the handover being initiated during the ongoing call at the UE; and
configuring a status of the always-on PDU session as inactive for the 3GPP network to prevent the transmission of the at least one service request to the 3GPP network during the handover, based on the handover being initiated during the always-on PDU session at the UE.

11. The UE of claim 10, wherein the operations further comprises:
receiving at least one RTP packet from an internet protocol multimedia subsystem (IMS) to trigger the at least one service request to the 3GPP network to get user plane resources for an IMS packet data unit (PDU), during the handover; and
storing the at least one received RTP packet to avoid triggering of the at least one service request to the 3GPP network during the handover, to obtain at least one stored RTP packet.

12. The UE of claim 10, wherein the operations further comprises:
based on the handover being initiated during the ongoing call at the UE, determining whether the handover is successful;
deleting the at least one suspended RTP packet, based on the handover being successful; and
resuming transmission of the at least one suspended RTP packet on the 3GPP network, based on the handover being unsuccessful.

13. The UE of claim 11, wherein the operations further comprises:
based on the handover being initiated during the ongoing call at the UE, determining whether the handover is successful;
routing the at least one stored RTP packet and the at least one suspended RTP packet on the non-3GPP network, based on the handover being successful; and
resuming transmission of the at least one stored RTP packet and the at least one suspended RTP packet on the 3GPP network, based on the handover being unsuccessful.

14. The UE of claim 13, wherein the operations further comprises deleting the at least one stored RTP packet from the communication processor.

15. The UE of claim 10, wherein for the handover during the ongoing call, the operations further comprise:
registering for access to the 3GPP network;
starting a call on the 3GPP network based on the registering by initiating an internet protocol multimedia subsystem (IMS) PDU session;
moving from the 3GPP network to the non-3GPP network during the ongoing call;
establishing a secure connection with the non-3GPP network;
moving from the IMS PDU session from the 3GPP network to the non-3GPP network; and
receiving a data radio bearer (DRB) release on the 3GPP network new radio (NR) once connection is moved to the non-3GPP network.

16. The UE of claim 15, wherein prevention of transmission of the at least one service request to the 3GPP network during the handover occurs is caused due to at least one of:
not releasing the IMS PDU session corresponding to the ongoing call by a session management function (SMF) so as to maintain a session management context between an access and mobility management function (AMF) and the SMF,
releasing, by the 3GPP network, a corresponding DRB for the IMS PDU session while moving the IMS PDU session from 3GPP access to non-3GPP access, or
at least one pending RTP packet to be sent on the 3GPP access during the handover.

17. The UE of claim 10, wherein configuring the status of the always-on PDU session as inactive for the 3GPP network comprises:
starting an internet key exchange (IKEv2) session on the non-3GPP network;
transmitting the initiation of the handover to the 3GPP network through the non-3GPP network at a predefined trigger point; and
configuring the status of the always-on PDU session as inactive for the 3GPP network.

18. The UE of claim 10, wherein the operations further comprise:
based on the handover being initiated during the always-on PDU session at the UE, receiving the initiation of the handover during the always-on PDU session at the UE; and
configuring the status of the always-on PDU session from inactive to active for the 3GPP network.

19. A non-transitory computer readable storage medium storing instructions, which, when executed by at least one processor of a user equipment (UE) cause the UE to perform operations comprising:
identifying an initiation of a handover of the UE from a 3rd generation partnership project (3GPP) network to a non-3GPP network;
determining whether the handover is initiated during an ongoing call at the UE, or an always-on packet data unit (PDU) session at the UE;
suspending at least one suspended real-time transport protocol (RTP) packet on the 3GPP network to prevent transmission of at least one service request to the 3GPP network during the handover, based on the handover being initiated during the ongoing call at the UE); and
configuring a status of the always-on PDU session as inactive for the 3GPP network to prevent the transmission of the at least one service request to the 3GPP network during the handover, based on the handover being initiated during the always-on PDU session at the UE.

20. The non-transitory computer readable storage medium of claim 19, wherein the operations further comprises:
receiving at least one received RTP packet from an internet protocol multimedia subsystem (IMS) to trigger the at least one service request to the 3GPP network to get user plane resources for an IMS PDU, during the handover; and
storing the at least one received RTP packet to avoid triggering of the at least one service request to the 3GPP network during the handover, to obtain at least one stored RTP packet.
